(19) United States
(12) Patent Application Publication
(10) Pub. No.: US 2022/0101380 A1
(43) Pub. Date: Mar. 31, 2022

(54) SCHEDULING DEVICE, SCHEDULING METHOD AND RECORDING MEDIUM

(71) Applicant: NEC Corporation, Minato-ku, Tokyo (JP)

(72) Inventors: Yasuhisa SUZUKI, Tokyo (JP); Werner WEE, Tokyo (JP)

(73) Assignee: NEC Corporation, Minato-ku, Tokyo (JP)

(21) Appl. No.: 17/426,264

(22) PCT Filed: Jan. 31, 2019
(86) PCT No.: PCT/JP2019/003378

§ 371 Date: Jul. 28, 2021

(51) Int. Cl. G06Q 30/02

(52) U.S. Cl. CPC G06Q 30/0264

(57) ABSTRACT

Based on decided schedule data pertaining to an object to be scheduled and a feature of the object to be scheduled, an objective function used for generating schedule data for an object to be scheduled is calculated. Schedule data for the object to be scheduled scheduling of which is undecided is generated by using a feature of the object to be scheduled scheduling of which is undecided and the objective function.

### TECHNICAL FIELD

The present invention relates to a scheduling device, a scheduling method and a recording medium.

### BACKGROUND ART

Considerable effort is devoted to scheduling an object to be scheduled on the basis of its feature. For example, the work of determining the date and time when an advertisement is to be broadcast requires a worker to expend a lot of effort.

As a related technique, Patent Document 1 discloses a technique for creating a program table defining a temporal arrangement of a plurality of contents to be distributed to users according to the users' preferences and situations.

### PRIOR ART DOCUMENTS

### Patent Documents

[Patent Document 1] PCT International Publication No. WO 2005/096629

### SUMMARY OF THE INVENTION

### Problem to be Solved by the Invention

In the scheduling work described above, a technique is desired in which a general worker can automatically generate schedule data similar to a skilled worker.

### Means for Solving the Problem

A scheduling device according to one example embodiment of the present invention includes a learning unit that calculates, based on decided schedule data pertaining to the object to be scheduled and a feature of an object to be scheduled, an objective function used for generating schedule data for the object to be scheduled and constraints; and a scheduling unit that generates schedule data for an object to be scheduled scheduling of which is undecided, by using a feature of the object to be scheduled scheduling of which is undecided, the objective function, and the constraints.

A scheduling method according to one example embodiment of the present invention includes: calculating, based on decided schedule data pertaining to an object to be scheduled and a feature of the object to be scheduled, an objective function used for generating schedule data for the object to be scheduled and constraints; and generating schedule data for an object to be scheduled scheduling of which is undecided, by using a feature of the object to be scheduled scheduling of which is undecided, the objective function, and the constraints.

A recording medium according to one example embodiment of the present invention records a program that causes a computer to function as: a learning means that calculates, based on decided schedule data pertaining to an object to be scheduled and a feature of the object to be scheduled, an objective function used for generating schedule data for the object to be scheduled and constraints; and a scheduling means that generates schedule data for an object to be scheduled scheduling of which is undecided, by using a feature of the object to be scheduled scheduling of which is undecided, the objective function, and the constraints.

### Effect of Invention

According to the present invention, it is possible to provide a scheduling device, a scheduling method, and a recording medium that automatically generate schedule data similar to a worker who is skilled in scheduling work.

### BRIEF DESCRIPTION OF THE DRAWINGS

FIG. 1 is a diagram showing an outline of a scheduling system.

FIG. 2 is a diagram showing a hardware configuration of a scheduling device.

FIG. 3 is a function block diagram of a scheduling device.

FIG. 4 is a diagram showing a processing flow of a scheduling device according to the first example embodiment.

FIG. 5 is a diagram showing a processing flow of a scheduling device according to a second example embodiment.

FIG. 6 is a diagram showing a minimum configuration of a scheduling device.

FIG. 7 is a diagram showing a processing flow of a scheduling device having the minimum configuration.

### EXAMPLE EMBODIMENT

Hereinbelow, a scheduling device according to an example embodiment of the present invention will be described with reference to the drawings.

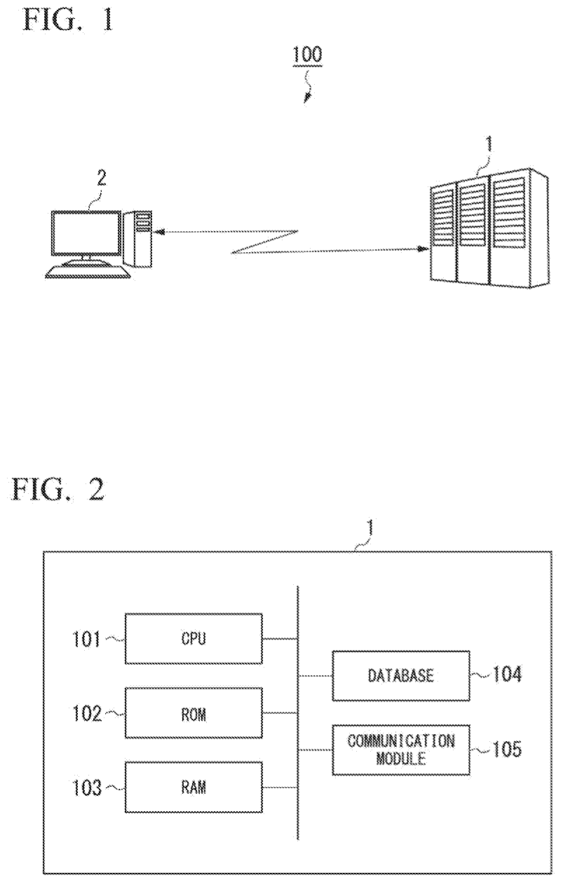

FIG. 1 is a diagram showing an outline of a scheduling system including a scheduling device according to the same example embodiment.

As shown in this figure, a scheduling system 100 is configured by a scheduling device 1 and a terminal 2 being communicatively connected. The terminal 2 outputs input information from a worker to the scheduling device 1. The scheduling device 1 automatically generates schedule data of an object to be scheduled, which is similar to a worker who is skilled in scheduling work, on the basis of the input information indicating an instruction of the worker.

FIG. 2 is a diagram showing a hardware configuration of the scheduling device 1.

As shown in this figure, the scheduling device 1 is a computer including hardware such as a CPU (Central Processing Unit) 101, a ROM (Read Only Memory) 102, a RAM (Random Access Memory) 103, a database 104, and a communication module 105. The terminal 2 is also a computer having similar hardware.

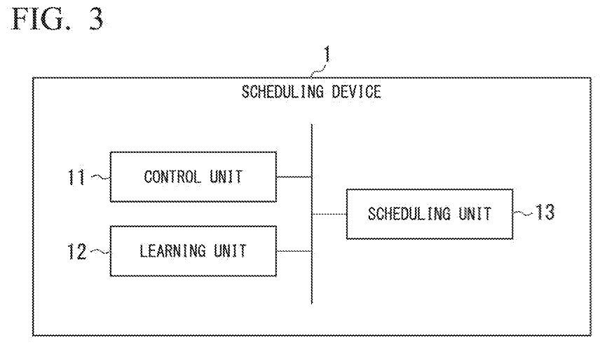

FIG. 3 is a function block diagram of the scheduling device.

The CPU 101 of the scheduling device 1 starts when the power is turned on, and executes a scheduling program stored in advance. Thereby, the scheduling device 1 exhibits the functions of the control unit 11, the learning unit 12, and the scheduling unit 13.

The control unit 11 controls other functions of the scheduling device 1.

The learning unit 12 calculates an objective function and constraints used for generating schedule data for the object to be scheduled on the basis of decided schedule data pertaining to the object to be scheduled and a feature of the object to be scheduled. The scheduling unit 13 generates schedule data for the object to be scheduled the scheduling of which is undecided, using the feature of the object to be scheduled the scheduling of which is undecided, the objective function, and the constraints.

Here, in the present example embodiment, the object to be scheduled is an advertisement broadcast, and the schedule data indicates the schedule of the program broadcast and the advertisement broadcast. In such a case, the learning unit 12 may calculate an objective function for each advertisement broadcast. Further, the learning unit 12 may calculate the objective function and the constraints for each group determined on the basis of the feature of the advertisement broadcast. Further, the scheduling unit 13 specifies a group on the basis of a feature of a new advertisement broadcast, and generates schedule data of the advertisement broadcast the scheduling of which is undecided by using the objective function and the constraints calculated for the group.

### <First Example Embodiment>

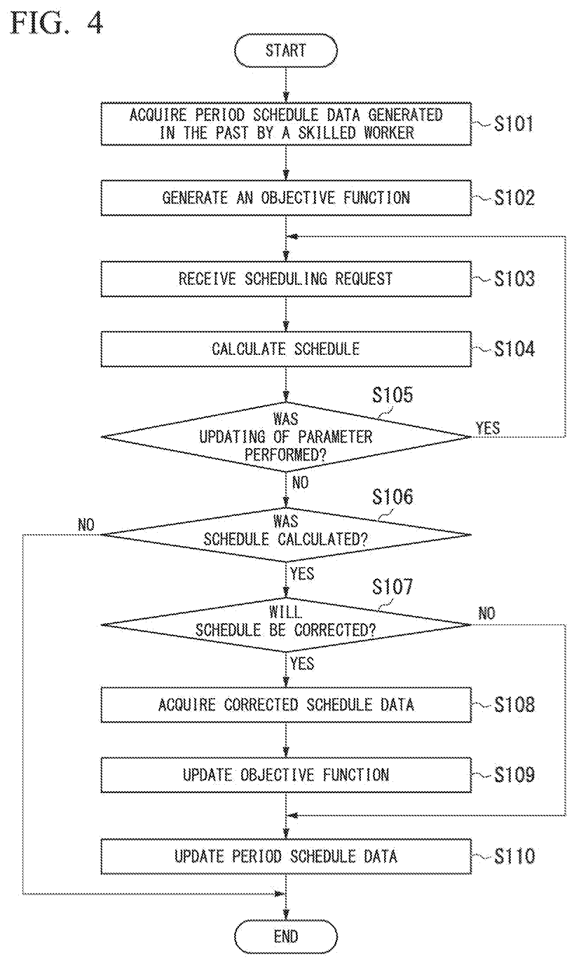

FIG. 4 is a diagram showing a processing flow of a scheduling device according to the first example embodiment.

Next, the processing flow of the scheduling device 1 according to the first example embodiment will be described.

A database 104 of the scheduling device 1 stores schedule data generated by a worker such as a skilled worker in the past. The learning unit 12 acquires instruction information for starting the processing. The processing start instruction information may be input by the worker using the terminal 2 and may be received by the scheduling device 1 via a communication network. Alternatively, the worker may directly input the processing start instruction information into the scheduling device 1 by using an input device provided in the scheduling device 1.

The learning unit 12 acquires period schedule data Xe={x₁, x₂, X₃, . . . X_{M}} generated in the past by a worker such as a skilled worker from the database 104 on the basis of acquisition of instruction information (Step S101). The period schedule data Xe includes at least an advertisement schedule x (x₁, x₂, x₃, . . . x_{M}) for each advertisement broadcast. The learning unit 12 may sequentially acquire the advertisement schedule x for each advertisement broadcast included in the period schedule data Xe generated in the past by a skilled worker one by one. The period schedule data Xe={x₁, x₂, x₃, . . . x_{M}} generated in the past by a worker such as a skilled worker includes the schedule of each advertisement broadcast allocated in a predetermined broadcast contract period. The advertisement schedule x includes information on the individual schedule of the advertisement broadcast and feature information of the advertisement broadcast. The period schedule data Xe may include program information including the date and time and a feature of the program in addition to information of the advertisement schedule x.

Here, it is assumed that the period schedule data Xe generated in the past by a worker such as a skilled worker is the result of solving the following mathematical optimization.

$$\begin{matrix}[ Equation 1 ] & \\ {max}_{x} {θ}^{T} Φ ( x ) , s . t . x ∈ X & ( 1 )\end{matrix}$$

In Equation (1), θ is a unique parameter according to the worker such as a skilled worker, and is a specific parameter that determines the scheduling method of the worker such as a skilled worker. In Equation (1), only the value of θ is unknown. φ represents feature information and the constraints of the advertisement schedule x. As an example, the feature information includes information such as the age group and gender targeted by the advertisement broadcast, day of the week to be broadcast, content type of the advertisement, type of program to be broadcasted before and after the broadcast time of the advertisement broadcast, and the like. As an example, the constraints includes information such as the time slot in which the broadcast must be carried out, the type of program to be broadcast before or after the advertisement broadcast is performed, and the like. Equation (1) means that a worker such as a skilled worker creates an advertisement broadcast schedule x that maximizes the value of θ^{T}φ(x).

The learning unit 12, by using the period schedule data Xe={x₁, x₂, x₃, . . . x_{M}} generated in the past by a worker such as a skilled worker, estimates the unique parameter θ of the worker such as a skilled worker by inverse optimization. More specifically, the learning unit 12 performs inverse optimization based on the maximum likelihood method.

$$\begin{matrix}[ Equation 2 ] & \\ {θ}^{*} = {argmax}_{θ} p ( {X}_{e} \vert θ ) & ( 2 )\end{matrix}$$

In a situation where the period schedule data Xe generated in the past by a worker such as a skilled worker is given, a parameter θ* that maximizes the likelihood p (Xe|θ) is set to be a parameter of the worker such as a skilled worker. For the likelihood p (Xe|θ), for example, the following Equation (3) is used.

$$\begin{matrix}[ Equation 3 ] & \\ p ( {x}_{i} \vert θ ) = \frac{exp {θ}^{T} Φ ( {x}_{i} )}{{\sum }_{{x}_{i} ∈ X} exp {θ}^{T} Φ ( {x}_{i} )} & ( 3 )\end{matrix}$$

When the logarithm is taken assuming that the period schedule data Xe={x₁, x₂, x₃, . . . x_{M}} generated in the past by a worker such as a skilled worker is generated from an independent identical distribution, Equation (2) becomes the following Equation (4).

$$\begin{matrix}[ Equation 4 ] & \\ {θ}^{*} = {argmax}_{θ} ( {\sum }_{i = 1}^{M} log p ( {x}_{i} \vert θ ) ) & ( 4 )\end{matrix}$$

The learning unit 12 calculates θ^{new} that is generated by updating the parameter θ* using the steepest ascent method.

$$\begin{matrix}[ Equation 5 ] & \\ {θ}^{new} = {θ}^{old} + α \frac{θ}{\partial θ} log p ( {x}_{i} \vert θ ) & ( 5 )\end{matrix}$$

The learning unit 12 can determine an arbitrary value for α by the step size. Further, when the learning unit 12 adopts Equation (3) as the equation expressing the likelihood p, the parameter is updated as shown in the following Equation (6).

θ^{new}=θ^{old}+α(Φ(xᵢ)−Φ(x)) (6)

In the above Equation (6), Φ (xᵢ) is a feature amount extracted from the advertisement schedule x of the advertisement broadcast to be processed of the period schedule data Xe generated in the past by a worker such as a skilled worker. φ (xᵢ) is a feature amount of the advertisement schedule x generated under the parameter θ^{old}. The learning unit 12 may separately acquire the advertisement schedule x for each advertisement broadcast included in the period schedule data Xe generated in the past by a skilled worker, and in this case, sequentially updates the unique parameter of the workers such as a skilled worker by the above processing. Then, the learning unit 12 generates an objective function including the parameter θ^{new} for the entire advertisement broadcast included in the period schedule data Xe generated in the past by a worker such as a skilled worker (Step S102).

In such a state, a new worker performs scheduling of a new advertisement broadcast using the terminal 2. At this time, the terminal 2 communicatively connects with the scheduling device 1 by the operation of the worker. Further, the terminal 2 outputs a scheduling request including CM data related to the advertisement broadcast to the scheduling device 1 by the operation of the worker. The CM data includes feature information and constraints pertaining to an advertisement broadcast. As described above, the feature information includes information such as the age group and gender targeted by the advertisement broadcast, the day of the week of the broadcast, the content type of the advertisement, and the type of program to be broadcast before and after the broadcast time of the advertisement broadcast. The constraints may be a time slot in which the broadcast must be carried out, the type of program to be broadcast before or after the advertisement broadcast, and the like. The constraints may be stored in advance by the scheduling device 1, and the constraints may be used.

The scheduling device 1 receives a scheduling request from the terminal 2 (Step S103). The scheduling unit 13 of the scheduling device 1 acquires CM data included in the received scheduling request. The scheduling unit 13 acquires the feature information and the constraints of the advertisement broadcast from the CM data. The scheduling unit 13 acquires the objective function generated by the learning unit 12. The scheduling unit 13 inputs to the objective function (Equation (7)) the feature information and constraints, and the entire data (schedule) of the schedule including the period for scheduling the advertisement broadcast, the advertisement broadcasts already set in that period and the date and time of the advertisement broadcasts. As a result, the scheduling unit 13 calculates the optimum schedule of the advertisement broadcast corresponding to the CM data included in the scheduling request (Step S104). The schedule includes at least information on the date and time of the advertisement broadcast.

$$\begin{matrix}[ Equation 7 ] & \\ {max}_{( schedule )} J ( schedule , θ ) & ( 7 )\end{matrix}$$

If the schedule cannot be calculated, the scheduling unit 13 may accept a correction of the constraints and feature information included in the CM data of the advertisement broadcast. For example, the scheduling unit 13 transmits the calculated schedule data to the terminal 2. The worker using the terminal 2 confirms the schedule data calculated for the advertisement broadcast, and determines whether that date and time is a time already filled by another advertisement broadcast. Then, the worker updates a parameter such as the feature information or constraints included in the CM data, and re-requests a scheduling request. Then, the terminal 2 transmits the scheduling request with the updated parameter to the scheduling device 1. The scheduling unit 13 determines whether the updating of the parameter has been performed (Step S105). At this time, the scheduling unit 13 again determines that the updating of the parameter has been performed on the basis of the information included in the scheduling request. When the parameter has been updated, the scheduling device 1 repeats the process of calculating the schedule in Step S104 described above.

The scheduling unit 13 may automatically determine whether the schedule data calculated for the advertisement broadcast is a time already filled with another advertisement broadcast. In this case, the scheduling unit 13 updates the parameter D such as the feature information or constraints included in the CM data by the specified update process, and repeats the schedule calculation process. Then, the scheduling unit 13 determines whether or not the schedule of the advertisement broadcast specified by the scheduling request can be calculated (Step S106). The scheduling unit 13 ends the process upon determining that the schedule has been calculated such as when the schedule of the advertisement broadcast cannot be calculated even if the parameter D is updated a predetermined number of times, when there is no time in which the advertisement broadcast can be applied in the free time in the entire schedule data, or when an end request is received from the terminal 2 on the basis of an operation by the worker.

The scheduling unit 13, upon determining that the schedule of the advertisement broadcast specified by the scheduling request has been calculated, determines whether to correct the schedule (Step S107). For example, the scheduling unit 13 transmits inquiry information on the necessity of schedule correction to the terminal 2. The information includes data of the calculated schedule. The terminal 2 outputs the schedule data to a monitor or the like. The worker confirms the content of the schedule data and determines whether or not to make a correction. When the worker corrects the schedule, the worker inputs correction information into the terminal 2. It is assumed that the worker who makes the correction is a worker such as a skilled worker. The correction information is the date and time indicating a schedule the scheduling of which is undecided. Then, the terminal 2 transmits the corrected schedule data to the scheduling device 1 on the basis of an operation of the worker.

The scheduling unit 13 acquires the corrected schedule data (Step S108). The scheduling unit 13, upon receiving the corrected schedule data, determines to perform updating of the objective function. Similar to the process in Step S102, the scheduling unit 13 generates an objective function including the parameter θ^{new} using the corrected schedule data, and updates the objective function (Step S109).

Then, the scheduling unit 13 updates the entire period schedule data indicating the schedule of a plurality of advertisement broadcasts and programs, including the schedule data calculated in Step S104 or the corrected schedule data acquired in Step S107 (Step S110).

Through the above processing, the scheduling device 1 calculates an objective function to be used for generating the schedule data for an object to be scheduled on the basis of decided schedule data pertaining to the object to be scheduled and a feature of the object to be scheduled. At this time, the scheduling device 1, on the basis of the decided schedule data generated in the past, uses an inverse optimization method to calculate the objective function including a parameter specific to the scheduling method of the worker (skilled worker or the like) who generated the decided schedule data. Then, the scheduling device 1 generates schedule data for an object to be scheduled the scheduling of which is undecided using the feature of the object to be scheduled the scheduling of which is undecided and the objective function.

By such processing, the scheduling device 1 can provide a scheduling device that automatically generates schedule data similar to a worker (skilled worker or the like) who generated decided schedule data.

### <Second Example Embodiment>

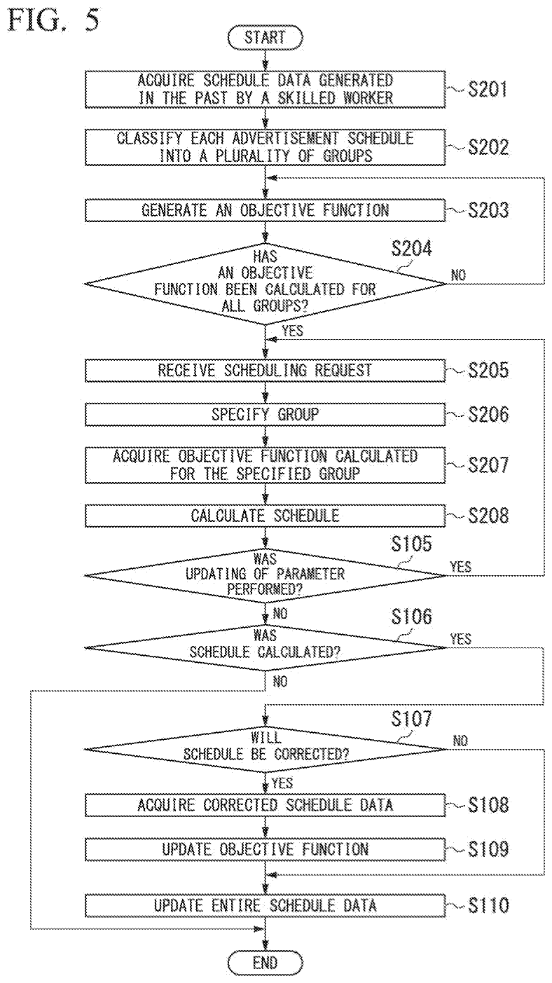

FIG. 5 is a diagram showing a processing flow of a scheduling device according to a second example embodiment.

Next, the processing flow of the scheduling device according to the second example embodiment will be described.

The database 104 of the scheduling device 1 stores schedule data generated by a worker such as a skilled worker in the past. The learning unit 12 acquires instruction information for starting the processing. The processing start instruction information may be input by the worker using the terminal 2 and may be received by the scheduling device 1 via a communication network. Alternatively, the worker may directly input the instruction information into the scheduling device 1 by using the input device included in the scheduling device 1.

The learning unit 12 acquires period schedule data Xe={x₁, x₂, x₃, . . . x_{M}} generated in the past by a worker such as a skilled worker from the database 104 on the basis of acquisition of the instruction information (Step S201). The period schedule data Xe includes at least an advertisement schedule x (x₁, x₂, x₃, . . . x_{M}) for each advertisement broadcast. The learning unit 12 may acquire one by one the advertisement schedule x for each advertisement broadcast included in the period schedule data Xe generated in the past by a skilled worker. The period schedule data Xe={x₁, x₂, x₃, . . . x_{M}} generated in the past by a worker such as a skilled worker includes the schedule of each advertisement broadcast allocated in a predetermined broadcast contract period. The advertisement schedule x includes information on the individual schedule of the advertisement broadcast and feature information of the advertisement broadcast. The period schedule data Xe may include program information including the date and time and a feature of the program in addition to information of the advertisement schedule x.

The learning unit 12 classifies each advertisement schedule x included in the acquired period schedule data Xe into a plurality of groups (Step S202). For example, the learning unit 12 performs clustering and classification using a K-Means clustering method or the like based on the feature information of each advertisement schedule x. The learning unit 12 may perform classification into a plurality of groups based on past schedule data created by a worker such as a skilled worker. In this case, the learning unit 12 extracts a feature amount from the schedule data and classifies each advertisement schedule x into a plurality of groups based on the feature amount. The feature amount may be an audience rating acquired on each day of the week, an audience rating acquired in each time slot, or the like. When performing classification based on past schedule data, group allocation cannot be performed for new advertisement broadcasts because there is no past schedule. For this reason, the worker may be allowed to classify the advertisement schedule x into a plurality of groups.

When the process of classifying each advertisement schedule x into a plurality of groups is completed, the learning unit 12 uses the feature information of each advertisement schedule x included in the group to perform the inverse optimization process as in the first example embodiment. Then, the learning unit 12 generates an objective function including the parameter θ^{new} for the group including each advertisement schedule x generated in the past by a worker such as a skilled worker, in the same manner as in the first example embodiment (Step S203). The learning unit 12 determines whether or not the objective function has been calculated for all the groups (Step S204). The learning unit 12 repeats the process until the objective functions for all the groups are calculated. The learning unit 12 may perform the calculation process of the objective function immediately after performing the process of classifying each advertisement schedule x into a plurality of groups, or may perform each process at different timings. When the learning unit 12 performs the calculation process of the objective function immediately after performing the process of classifying each advertisement schedule x into a plurality of groups, the learning unit 12 may perform those processes using the same feature information. When the process of classifying each advertisement schedule x into a plurality of groups and the objective function calculation process are performed at different timings, the learning unit 12 may perform those processes using different feature information.

In such a state, a new worker performs scheduling of a new advertisement broadcast using the terminal 2. At this time, the terminal 2 communicatively connects with the scheduling device 1 by the operation of the worker. Further, the terminal 2 outputs a scheduling request including CM data related to the advertisement broadcast to the scheduling device 1 by the operation of the worker. The CM data includes feature information and constraints related to an advertisement broadcast. As described above, the feature information includes information such as the age group and gender targeted by the advertisement broadcast, the day of the week of the broadcast, the content type of the advertisement, and the type of program broadcast before and after the broadcast time of the advertisement broadcast. The constraints may be a time slot in which the broadcast must be carried out, the type of program to be broadcast before or after performing the advertisement broadcast, and the like. The constraints may be stored in advance by the scheduling device 1, and the constraints may be used.

The scheduling device 1 receives a scheduling request from the terminal 2 (Step S205). The scheduling unit 13 of the scheduling device 1 acquires CM data included in the received scheduling request. The scheduling unit 13 acquires the feature information and the constraints of the advertisement broadcast from the CM data. The scheduling unit 13 specifies the group on the basis of the feature information and the constraints acquired from the CM data (Step S206). For example, the scheduling unit 13 specifies a group including respective advertisement schedules that are classified in the same group based on the feature information and the constraints which are similar to the feature information and the constraints acquired from the CM data. The specification of the group may be performed by the worker using the terminal 2. For example, the terminal 2 may transmit the group ID to the scheduling device 1 based on the instruction of the worker, and the scheduling unit 13 may specify the group on the basis of that group ID.

Then, the scheduling unit 13 acquires the objective function calculated by the learning unit 12 for the specified group (Step S207). The scheduling unit 13 inputs to the objective function (Equation (7)) the feature information and constraints, and the entire data (schedule) of the schedule including the period for scheduling the advertisement broadcast, the advertisement broadcasts already set in that period and the date and time of the advertisement broadcasts. As a result, the scheduling unit 13 calculates the optimum schedule of the advertisement broadcast corresponding to the CM data included in the scheduling request (Step S208). The schedule includes at least information on the date and time of the advertisement broadcast. Subsequently, the scheduling unit 13 performs similar processing as in steps S105 to S110 of the first example embodiment.

Through such processing, the scheduling device 1, using a specific objective function for the group to which the advertisement broadcast the scheduling of which is undecided belongs, can provide a scheduling device that automatically generates schedule data similar to a worker who is skilled in the scheduling work with high accuracy.

According to the above-mentioned process, a description was given using the example of scheduling of an advertisement broadcast, but the scheduling device 1 may be a device that schedules employee shifts using similar process to the first example embodiment or the second example embodiment.

For example, the scheduling device 1 calculates an objective function that is used to generate schedule data of employees on the basis of predetermined schedule data pertaining to work shift schedules of employees in a store or factory and features of the employees to be scheduled. At this time, the scheduling device 1, on the basis of the predetermined schedule data generated in the past by a worker such as a skilled worker, uses an inverse optimization method to calculate the objective function including a parameter specific to the scheduling method of the worker such as a skilled worker. In the calculation of the objective function, the scheduling device 1 may calculate the objective function for each group determined based on the feature of the employee. Then, the scheduling device 1 generates schedule data of the employee whose schedule has not been determined by using the features of the employee whose schedule has not been determined and the objective function. The scheduling device 1 may specify a group on the basis of the feature of unscheduled employees, and generate schedule data of the unscheduled employees by using the objective function calculated for the group.

The number of employees such as telemarketers in workplaces is very large, and the conditions for not being able to go to work differ depending on the individual. For this reason, it is very laborious to manually design employee shifts while observing all prohibitions. Even if a shift is designed using related automatic scheduling software that uses mathematical optimization, at the design stage, when there are conditions that cannot be clearly formulated such as detailed conditions for individual employees like “days in which it is not impossible to go to work but I would like to avoid working as much as possible” or “if possible, I would prefer to concentrate on specific days of the week”, expression by manual design is unavoidable. Such work is also very laborious. Therefore, it is difficult with related technology to perform scheduling that meets the detailed conditions of employees. However, by learning an objective function for each employee by inverse optimization using the process of the present application as described above, it is possible to automatically design the objective function used at the time of scheduling. In addition, weighting of constraints that cannot be clearly stated as mentioned above can also be learned from the features of employees. This makes it possible to perform scheduling according to each employee's request. In addition, by using employee grouping as a way of dealing with new employees, employees can be classified and grouped according to their features (desired time slot, and the like). For new employees, first determine which group they belong to, then perform scheduling using the objective function associated with that group.

Further, when the scheduling device 1 allocates a plurality of jobs to a plurality of machines by using similar processing as in the first example embodiment or the second example embodiment, a schedule may be generated that specifies which jobs to assign to which machines and in what order.

In this case, the scheduling device 1 calculates an objective function used for generating schedule data for work to be scheduled on the basis of predetermined schedule data pertaining to a shift schedule that assigns a plurality of different jobs to machines and the feature of the work to be scheduled. At this time, the scheduling device 1, on the basis of the predetermined schedule data generated in the past by the worker such as a skilled worker, calculates an objective function including a parameter specific to the scheduling method of the worker such as a skilled worker by using an inverse optimization method. In the calculation of this objective function, the scheduling device 1 may calculate the objective function for each group determined based on the feature of the work. Then, the scheduling device 1, using a feature of the unscheduled work and the objective function, generates schedule data of the unscheduled work. The scheduling device 1 specifies a group on the basis of the feature of the unscheduled work, and uses the objective function calculated for the group to generate schedule data of a machine or time to which the unscheduled work is assigned. Thereby, when assigning a plurality of jobs to a plurality of machines, it is possible to generate a schedule that stipulates which work is assigned to which machine and in which order.

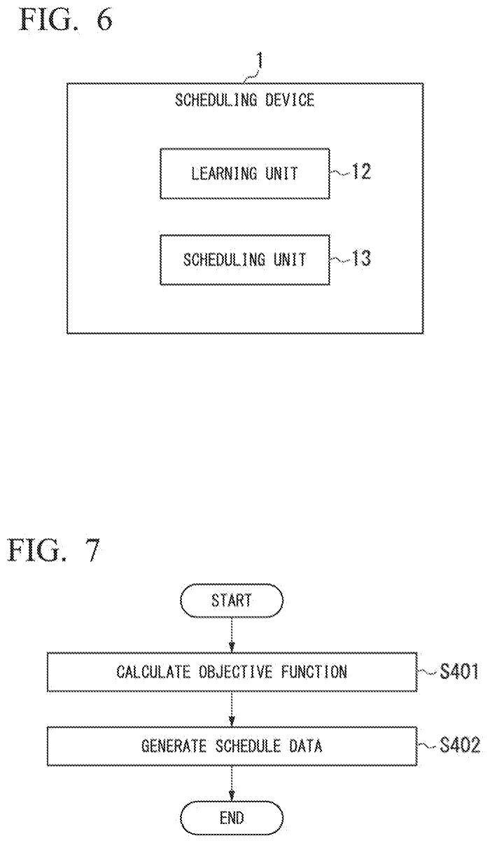

FIG. 6 is a diagram showing a minimum configuration of the scheduling device.

FIG. 7 is a diagram showing a processing flow of the scheduling device having the minimum configuration.

As shown in FIG. 6, the scheduling device exhibits at least the functions of the learning unit 12 and the scheduling unit 13.

The learning unit 12 calculates an objective function used for generation of the schedule data of an object to be scheduled on the basis of predetermined schedule data pertaining to the object to be scheduled and a feature of the object to be scheduled (Step S401).

The scheduling unit 13 generates schedule data for the object to be scheduled the scheduling of which is undecided, using the feature of the object to be scheduled the scheduling of which is undecided, and the objective function (Step S402).

The scheduling device 1 described above has a computer system inside. The processing of each process described above is stored in a computer-readable recording medium in the form of a program, and the process is performed by the computer reading and executing this program. Here, the computer-readable recording medium refers to a magnetic disk, a magneto-optical disk, a CD-ROM, a DVD-ROM, a semiconductor memory, or the like. Further, this computer program may be distributed to a computer via a communication line, and the computer receiving the distribution may execute the program.

The above program may be for realizing some of the above-mentioned functions. Further, a so-called differential file (differential program) may be used, which can realize the above-mentioned functions in combination with a program already recorded in the computer system.

### REFERENCE SYMBOLS

1: Scheduling device

2: Terminal

11: Control unit

12: Learning unit

13: Scheduling unit

100: Scheduling system

What is claimed is:

1. A scheduling device comprising:
at least one memory configured to store instructions; and
at least one processor configured to execute the instructions to:
calculate, based on decided schedule data pertaining to an object to be scheduled and a feature of the object to be scheduled, an objective function used for generating schedule data for an object to be scheduled scheduling of which is undecided; and
generate the schedule data for the object to be scheduled scheduling of which is undecided, by using a feature of the object to be scheduled scheduling of which is undecided and the objective function.

2. The scheduling device according to claim 1, wherein the at least one processor is configured to execute the instructions to calculate, based on the predetermined schedule data generated in a past, the objective function including a parameter specific to a scheduling method of a worker who generated the decided schedule data, by using an inverse optimization method.

3. The scheduling device according to claim 1, wherein the at least one processor is configured to execute the instructions to calculate the objective function for each object to be scheduled.

4. The scheduling device according to claim 1, wherein the at least one processor is configured to execute the instructions to classify, for each of a plurality of objects to be scheduled, the object to be scheduled into one of a plurality of groups based on the feature of the object to be scheduled, and calculate the objective function for each group.

5. The scheduling device according to claim 4, wherein the at least one processor is configured to execute the instructions to specify, based on the feature of the object to be scheduled scheduling of which is undecided, a group to which the object to be scheduled scheduling of which is undecided belongs and generate the schedule data of the object to be scheduled scheduling of which is undecided by using the objective function calculated for the group.

6. The scheduling device according to claim 1,
wherein the object to be scheduled is an advertisement broadcast,
the schedule data is a broadcast schedule of an object to scheduled, and
the at least one processor is configured to generate the schedule data of the advertisement broadcast.

7. A scheduling method comprising:
calculating, based on decided schedule data pertaining to an object to be scheduled and a feature of the object to be scheduled, an objective function used for generating schedule data for an object to be scheduled scheduling of which is undecided; and
generating the schedule data for the object to be scheduled scheduling of which is undecided, by using a feature of the object to be scheduled scheduling of which is undecided and the objective function.

8. A non-transitory recording medium that records a program that causes a computer to execute:
calculating, based on decided schedule data pertaining to an object to be scheduled and a feature of the object to be scheduled, an objective function used for generating schedule data for an object to be scheduled scheduling of which is undecided; and
generating the schedule data for the object to be scheduled scheduling of which is undecided, by using a feature of the object to be scheduled scheduling of which is undecided and the objective function.
